(19) United States
(12) Patent Application Publication
(10) Pub. No.: US 2025/0263148 A1
(43) Pub. Date: Aug. 21, 2025

(54) Method for Operating a Drive Assembly of an Electric Bicycle

(71) Applicant: Robert Bosch GmbH, Stuttgart (DE)

(72) Inventors: Andreas Hastall, Stuttgart (DE); Christoph Heisen, Hoehenkirchen-Siegertsbrunn (DE); Ingbert Gerngross, Reutlingen (DE)

(21) Appl. No.: 19/052,502

(22) Filed: Feb. 13, 2025

(30) Foreign Application Priority Data
Feb. 21, 2024 (DE) 10 2024 201 591.1

(51) Int. Cl. B62M 6/50

(52) U.S. Cl. CPC B62M 6/50

(57) ABSTRACT

A method for operating a drive assembly of an electric bicycle includes (i) determining a deceleration of the electric bicycle, (ii) detecting an active braking operation based on the determined deceleration, and (iii) conducting a plausibility check of a brake signal based on the determined deceleration and detection of the braking operation.

This application claims priority under 35 U.S.C. § 119 to patent application no. DE 10 2024 201 591.1, filed on Feb. 21, 2024 in Germany, the disclosure of which is incorporated herein by reference in its entirety.

### BACKGROUND

The present disclosure relates to a method for operating a drive assembly of an electric bicycle, as well as to an electric bicycle.

Electric bicycles with drive assemblies are known which comprise a drive unit for generating a motor torque to provide motorized support to a manual pedaling force of a rider, and which comprise a braking system for decelerating an electric bicycle. Electric bicycles are also known in which generation of a drive torque by the drive unit must be prevented in the event brakes are actuated, for example due to statutory requirements. A brake signal, which is for example generated by a brake switch, is often used for this purpose. However, in the case of failures, such as a broken cable, reliable detection of brake actuation cannot always be ensured.

### SUMMARY

In contrast, the method according to the disclosure having the features set forth below is characterized by the fact that the brake signal of an electric bicycle can be checked in a particularly simple and reliable manner. In particular, the performance of the method can be enabled simply. This is achieved according to the disclosure by a method for operating a drive assembly of an electric bicycle, comprising the following steps:
determining a deceleration of the electric bicycle,
detecting an active braking operation based on the determined deceleration, and
conducting a plausibility check of a brake signal based on the determined deceleration and detection of the braking operation.

In particular, a reduction of a speed of the electric bicycle, that is, a slowdown, is considered to be a deceleration. In particular, a measure of the speed reduction is considered a deceleration.

Preferably, a braking operation caused directly by the rider of the electric bicycle is considered to be an active braking operation. That is to say, the active braking operation is effected by a targeted, in particular manual, brake actuation by the rider of the electric bicycle.

In particular, a signal representing the braking operation is considered a brake signal. For example, the brake signal may comprise an electrical signal representing the active braking operation. In particular, the brake signal may be generated by way of a signal device and/or a sensor and/or a brake actuating device.

The brake signal may preferably be used for further functions of the electric bicycle, for example a signal device, in particular in the form of a brake light. Particularly preferably, the brake signal may be used to deactivate a drive unit of the electric bicycle. That is, operation of the drive unit may be actively prevented in response to the generated brake signal.

In particular, a check of the brake signal to determine whether it is plausible is considered to be a plausibility check. That is to say, the plausibility check preferably checks to ensure the correct function of the brake signal, and in particular components involved therein, for example a brake switch. In particular, a plausibility check can determine whether a brake signal is also generated simultaneously in the event of a detected braking operation. Particularly preferably, if an active braking operation is detected, the check can determine whether a brake signal is also generated simultaneously.

In other words, in the method, for example, a deceleration of the electric bicycle is monitored and a braking operation, i.e., a braking operation caused by a targeted braking maneuver using a braking device of the electric bicycle, is detected via sensors. Detection of such an active braking operation is utilized to conduct a plausibility check the generation of a corresponding brake signal representing the braking operation.

The method thus offers the advantage that correct function of the generation of brake signals can be checked in a particularly simple and reliable manner. By explicitly detecting an active braking operation and conducting a plausibility check of a brake signal based thereon, among other things, the function of the braking system may be checked particularly reliably. In particular, a failure of brake signal generation can be easily and reliably detected. Thus, further functions based in particular on the brake signal, for example deactivation of motorized support, can be implemented particularly reliably or deactivated accordingly.

Preferred refinements of the disclosure are also set forth below.

Preferably, the deceleration is determined by directly detecting an acceleration of the electric bicycle, preferably by way of an accelerometer. In particular, a negative acceleration with respect to a direction of travel is detected as a deceleration. That is to say, a relevant acceleration that occurs during a braking operation is directly determined as a deceleration. Particularly preferably, a characteristic negative acceleration, for example with a specific time curve, can be detected as an active braking operation. An active braking operation can be detected easily and in particular unambiguously in this way.

Particularly preferably, the deceleration is determined by detecting a change in the speed of the electric bicycle. Preferably, the change in speed is detected by a speed sensor, which may comprise, for example, a wheel speed sensor. Preferably, a speed value and a change in speed over time may be detected. Alternatively, the change in speed may also be detected in other ways, for example, based on other sensor signals. Preferably, the change in speed may alternatively be determined based on a signal from a generator or dynamo. For example, a deceleration may be detected based on a decrease of a voltage frequency of the generated current. Thus, the deceleration and the active braking operation can be determined in a particularly simple and cost-efficient manner.

Preferably, an active braking operation is detected when an amount of the determined deceleration is greater than or equal to a predetermined deceleration threshold. The predetermined deceleration threshold is preferably at least 2 m/s², in particular at least 4 m/s². That is to say, the active braking operation is detected in particular when a level of deceleration is detected which can only be achieved by active braking using a braking system, and not by coasting, for example, on a slope. The active braking operation can thereby be detected particularly reliably and simply.

Preferably, determining the deceleration comprises determining a change in deceleration over time, wherein the plausibility check is performed additionally based on the determined change in deceleration over time. That is, a gradient of the deceleration, in particular a gradient of the negative acceleration, is additionally determined, the active braking operation is preferably detected, and the plausibility check of the brake signal is carried out based on that gradient. In particular, an active braking operation may be detected based on the determined change in deceleration over time being greater than a predetermined threshold value. Thus, every active braking operation can be detected and a plausibility check of the brake signal can be carried out on this basis particularly reliably.

Particularly preferably, the brake signal is a signal from a brake switch. A brake switch is in particular considered to be a switch, for example an electrical and/or mechanical switch, that generates the brake signal in response to actuation of a brake of the electric bicycle. For example, the brake switch may be actuated using a brake lever. For example, the brake signal may be used as a condition for operating the drive unit of the electric bicycle and/or for generating a signal with a brake signal light.

Preferably, a defect in the brake switch is detected by a plausibility check. In particular, the defect is detected when no brake signal is detected while an active braking operation is simultaneously detected. Preferably, an indication may be output to the operator of the electric bicycle in response to the detected defect of the brake switch. Alternatively or additionally preferably, one or more functions of the drive assembly, such as the ability to generate torque, may be deactivated in response to the detected defect. The method can thus be used to identify defects in the brake switch in a particularly simple and efficient manner.

Further preferably, the brake switch is configured to deactivate a drive unit of the drive assembly of the electric bicycle. In particular, the brake switch may prevent the drive unit from generating motor torque, preferably while a brake signal is generated, preferably by way of the brake signal itself. In other words, motorized support may be actively prevented when the brake is pulled by the brake switch.

Preferably, the plausibility check of the brake signal additionally comprises: detecting a brake actuation in response to a predetermined actuation situation, and determining a generation of the brake signal during the brake actuation. In particular, a situation in which brake actuation can be assumed is considered a predetermined actuation situation. Preferably, an indication is output to the operator of the electric bicycle during the actuation situation instructing the operator to apply the brake, preferably while the electric bicycle is at a standstill. That is, the rider is prompted by the system to manually brake such that the system can check the function of the brake signal generation through a plausibility check. Correct generation of the brake signal can thus be checked in a particularly simple manner.

Particularly preferably, the method further comprises the following step: determining a number of braking operations per predetermined travel cycle, wherein the plausibility check is performed additionally based on the determined number of braking operations per travel cycle. In particular, travel of the electric bicycle for a predetermined amount of time and/or over a predetermined distance may be considered a travel cycle. Preferably, the plausibility check may be performed by comparing the number of determined braking operations per travel cycle with a number of determined brake signals during that travel cycle. For example, a defect in the brake switch may be detected in response to a determined deviation. In this way, generation of the brake signal may be checked in a particularly reliable manner.

Further preferably, the deceleration is determined by way of an anti-lock braking system of the electric bicycle. In particular, an active braking operation may be determined based on signals from the anti-lock braking system. Thus, for example, the sensors and mode of operation of the anti-lock braking system can be utilized to reliably detect the active braking operation and to use the plausibility check of the brake signal.

Furthermore, the disclosure leads to an electric bicycle comprising a drive assembly and a control unit. The drive assembly preferably comprises a drive unit configured to generate motor torque in a controlled manner and a braking system preferably comprising a brake switch. The control unit is configured to carry out the described method.

### BRIEF DESCRIPTION OF THE DRAWINGS

An exemplary embodiment of the disclosure is explained in detail below with reference to the accompanying drawings. The drawing shows:

FIG. 1 is a simplified schematic view of an electric bicycle in which a method to operate a drive assembly of an electric bicycle according to a preferred exemplary embodiment example of the disclosure is carried out, and

FIG. 2 is a highly simplified schematic view of the method according to the disclosure.

### DETAILED DESCRIPTION

Preferably, all identical components, elements, and/or units are provided with the same reference symbols in all figures.

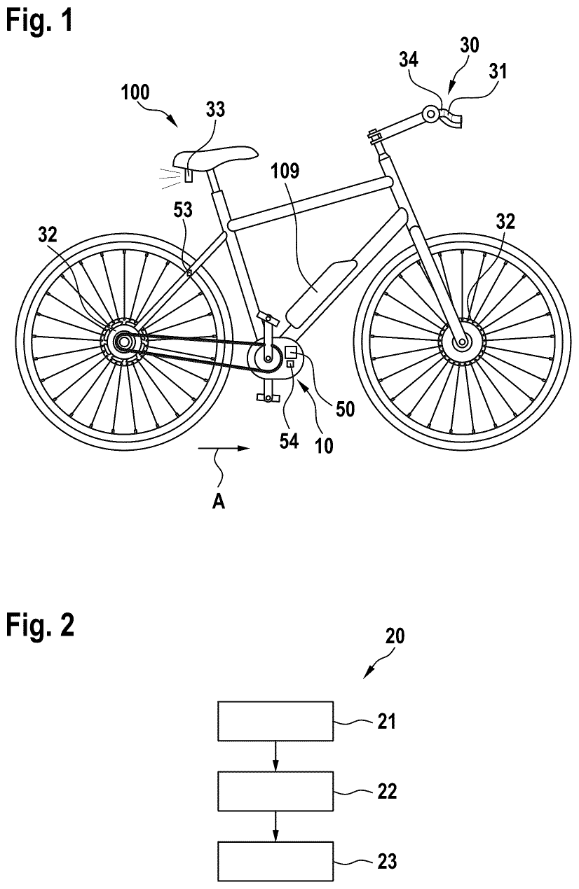

FIG. 1 shows a simplified schematic view of an electric bicycle 100 in which a method 20 to operate a drive assembly 10 of an electric bicycle 100 according to a preferred exemplary embodiment of the disclosure is carried out.

The drive assembly 10 comprises a drive unit having a motor, in particular an electric motor. The motor can be supplied with electrical energy by way of an electrical energy storage unit 109 of the electric bicycle 100.

The drive unit is arranged in the region of a bottom bracket of the electric bicycle 100. A motor torque generated by the motor can be used to provide motorized support for the pedal force generated by the muscle power of a rider of the electric bicycle 100. The muscle force of the rider can be applied via a crank mechanism.

The drive assembly 10 further comprises a control unit 50, which is configured to actuate the drive unit in a controlled manner. For example, the control unit 50 may control an electrical actuation current to actuate the motor of the drive unit.

In addition, the drive assembly 10 comprises a brake system 30, which includes brakes 32 and a brake lever 31. By way of the brake lever 31, a rider of electric bicycle 100 may cause manual actuation of brakes 32 to slow, that is, decelerate, the electric bicycle 100.

The brake system 30 also comprises a brake switch 34 on the brake lever 31 configured to generate a brake signal when the brake lever 31 is manually actuated.

When the brake signal is generated, it may be provided that the control unit 50 stops actuation of the drive unit, for example, in response to a received brake signal. In other words, when the brake signal is generated, operation of the drive unit is disabled.

Further, the brake system 30 may comprise a brake light 33 that outputs a light signal when the brake signal is generated to visually signal an active braking operation.

The method 20 is provided for checking the function of the brake signal generation by the brake system 30, that is, in particular for checking a function of the brake switch 34. The steps of method 20 are described below with respect to FIG. 2.

As the first step of the method 20, a deceleration of the electric bicycle 100 is determined 21. A negative acceleration of the electric bicycle 100 is detected directly by an accelerometer 54 as deceleration. That is, acceleration acting on electric bicycle 100 contrary to a direction of travel A (see FIG. 1) is recorded as a deceleration by way of the accelerometer 54.

Here, an active braking operation is detected 22 based on the determined deceleration. In detail, the active braking operation is detected when the determined acceleration corresponds to a predetermined acceleration. In particular, the deceleration is detected as an active braking operation, that is, a braking actuation initiated by a targeted braking operation, when the determined acceleration is greater than or equal to a predetermined deceleration threshold.

Additionally, a change in deceleration over time may be detected by way of the accelerometer 54. Thus, for example, a deceleration of the electric bicycle 100 caused by targeted braking may be detected particularly reliably.

Then, a plausibility check 23 of the brake signal is carried out based on the determined deceleration and the detected braking operation. That is, in particular, a check is performed to determine whether a signal is generated by the brake switch 34 during a detected braking operation.

A defect in the brake switch 34 can be detected by way of the plausibility check 23. In particular, a defect can be detected if there is no brake signal during the detected braking operation.

Operation of the drive unit may be automatically disabled, for example, in response to a detected defect in the brake switch, as a shutdown of the drive unit depending on the brake signal may no longer be reliably enabled.

Alternatively or additionally, the deceleration may be determined 21 by detecting a change in speed of the electric bicycle 100. The speed of the electric bicycle 100 can be detected in this respect preferably by way of a speed sensor 53, which may comprise, for example, a speed sensor on a rear wheel of the electric bicycle 100. Alternatively or additionally preferably, the change in speed may be detected, for example, by way of a dynamo and/or by way of an anti-lock braking system of the electric bicycle 100.

The method 20 offers the advantage that the function of the brake signal, and in particular the brake switch 34 can be checked in a particularly simple, reliable and cost-effective manner. By explicitly detecting an active braking operation effected by the rider and conducting a plausibility check of a brake signal based on the detected braking operation, whether a corresponding provided brake signal is generated can be checked in a particularly reliable manner. Thus, for example, further functions, in particular the deactivation of motorized support. can be implemented particularly reliably.

What is claimed is:

1. A method for operating a drive assembly of an electric bicycle, comprising:
determining a deceleration of the electric bicycle;
detecting an active braking operation based on the determined deceleration; and
conducting a plausibility check of a brake signal based on the determined deceleration and detection of the braking operation.

2. The method of claim 1, wherein the deceleration is determined by directly detecting an acceleration of the electric bicycle.

3. The method of claim 1, wherein the deceleration is determined by detecting a change in speed of the electric bicycle.

4. The method of claim 1, wherein an active braking operation is detected when the determined deceleration is greater than or equal to a predetermined deceleration threshold.

5. The method of claim 1, wherein:
the determining of the deceleration comprises determining a change in deceleration over time, and
the plausibility check is additionally carried out based on the determined change in deceleration over time.

6. The method of claim 1, wherein the brake signal is a signal of a brake switch.

7. The method of claim 6, wherein a plausibility check is used to detect a defect in the brake switch.

8. The method of claim 7, wherein the brake switch is configured to deactivate a drive unit of the drive assembly of the electric bicycle.

9. The method of claim 1, wherein the plausibility check of the brake signal additionally comprises:
detecting a brake actuation in response to a predetermined actuation situation, and
determining a generation of the brake signal during the brake actuation.

10. The method of claim 1, further comprising the step of determining a number of braking operations per predetermined travel cycle, wherein:
the plausibility check is performed additionally based on the determined number of braking operations per travel cycle.

11. The method of claim 1, wherein the deceleration is determined by way of an anti-lock braking system of the electric bicycle.

12. An electric bicycle, comprising:
a drive assembly; and
a control unit configured to perform a method according to claim 1.

13. The method of claim 2, wherein the deceleration is determined by directly detecting the acceleration of the electric bicycle using an accelerometer.

14. The method of claim 3, wherein the deceleration is determined by detecting the change in speed of the electric bicycle using a speed sensor.

15. The method of claim 1, wherein an active braking operation is detected when the determined deceleration is greater than or equal to at least 2 m/s².

16. The method of claim 1, wherein an active braking operation is detected when the determined deceleration is greater than or equal to at least 4 m/s².
